(19) United States
(12) Patent Application Publication
(10) Pub. No.: US 2015/0239532 A1
(43) Pub. Date: Aug. 27, 2015

(54) SURFBOARD FIN AND FIN BOX ADAPTER

(71) Applicant: Aldem Wood, San Diego, CA (US)

(72) Inventor: Aldem Wood, San Diego, CA (US)

(73) Assignee: Alden Wood, San Diego, CA (US)

(21) Appl. No.: 14/191,971

(22) Filed: Feb. 27, 2014

(51) Int. Cl. B63B 35/79; F16B 35/00

(52) U.S. Cl. CPC B63B 35/793; F16B 35/00

(57) ABSTRACT

The present invention is directed, in part, to an apparatus and methods related to an adapter for surfing or other water sports equipment that employ use of fins and fin boxes during their operation. Specifically, the present invention relates to an adapter that allows a surfer to fit a FCS® fin and engage it tightly and securely. The adapter, with the fin engaged, is fitted into the fin box of a surfboard that employs use of a Future® fin box. The user is able to quickly change a broken fin. The present invention is further directed to a system for attaching fins to surfboards that employs elements that allows a surfer to quickly replace broken or inoperable fins on the surfer's surfboard allowing replacement of such fins with new a new fin, even in the instance in which the fin and fin box originate from two different manufacturers.

### FIELD OF THE INVENTION

The present invention relates generally to an improved method and apparatus for enjoying the sport of surfing and other water sports that employ the use of fins and fin boxes and improving the equipment associated therewith. More specifically, the invention relates to an adapter that allows a surf rider the ability to use surfboard fins of one manufacturer interchangeably with the surfboard fin box of another, different manufacturer. Even more in particular, the present invention is an adapter that allows a surfer to use a FCS® fin and attach it securely to a Future® fin box.

### BACKGROUND OF THE INVENTION

Traditionally, the sport of surfing, which includes other sports such as for example, paddle boarding and the like, has been one that demands reliable equipment in order to maintain the safety of the individual as well provide equipment that will enhance enjoyment of the sporting experience to the greatest extent possible. There are a number of manufacturers in the business of providing surfing-related equipment and there is a variety of fins and fin boxes generally known in the art.

FCS® and Future® represent two significant players in the surfing industry with both companies enjoying a large market share in the sale of both fins and fin boxes as well as surfboards. Both companies supply the surfing industry with sturdy and reliable fins and fin boxes in order to allow the surfing community the ability to ride large waves without the fear that the fin and fin boxes will fail.

As with many types of sporting equipment, there is a multitude of variations on the basic configuration of surf board fins and fin boxes. Development of such equipment has sought to tailor the needs of a surfer along with ensuring that the equipment is able to take the rigorous conditions of found in the midst of large, crashing waves. Therefore, there is an obvious advantage for sporting enthusiasts to enjoy the flexibility of being able to use available surfing equipment interchangeably in order to find the fin and fin box, along with other available surfing equipment, that is going to best suit their needs in light of skill level, body type and surf conditions.

Interchangeable fin systems are known in the prior art and generally comprise different variations of fins that fit into a desired fin box or set of fin boxes. In fact, there is seemingly no shortage of examples that have attempted to address the lingering problem of a surfer's inability to easily and reliably use the fin of one manufacturer with the fin box of another different manufacturer. Examples are replete in the prior art and include for example, U.S. Pat. Nos. 5,830,025, 5,975,974, 7,497,752, 7,182,661 among a number of others.

U.S. Pat. No. 7,497,752 for example, describes multiple embodiments related to a fin box for releasable attachment of a fin having at least one fin-tab, with the fin box adapted to be inserted into and kept within the recesses of a surfboard. As described, the fin box includes an elongated body with a rectangular recess that allows the insertion of a fin therein. The patent describes a fin box system that is compatible with different fin manufacturers. The invention however, requires the fin box be installed while the board is getting shaped or initially created; it is not an accessory that can be added to an existing FCS® or Future® fin box in order to allow interchangeability.

U.S. Pat. No. 6,386,933 is another document that describes so-called customizable surfboards that employ use of an adjustable fin. As described, the surfboard includes a body, a fin, a recessed chamber and a fastener in which the fin can be inserted into the recessed chamber and fasted thereto with the fastener. More specifically, the recessed chamber is configured so that the fin is adjustable in a variety of cants so to allow the surfer the ability to ride the board in a variety of wave conditions.

U.S. Pat. No. 8,469,757 describes a fin and fin box assembly that includes a fin box that is adapted for attaching to a surfboard or other wave riding sporting equipment thereof. The fin box assembly is described as having a base that is attachable to the fin box wherein the fin assembly that can be readily attached or released from the fin box assembly. Again, as with the remainder of the prior art, the invention fails to address the long standing need of interchangeably mixing and matching the fins of one manufacturer with the fin box of another manufacturer.

Accordingly, difficulties in the field of surfboards, and the interchangeability of popular surfboard fins and fin boxes, remain. Further, existing solutions fail to address particular deficiencies that confront the surfing industry and the needs of surfers seeking alternatives to the existing art and a solution to advancing the freedom of using the sporting equipment that best suits the needs of the surfer in light of his skill level and the surfing conditions in which he seeks to surf. The present invention addresses these shortcomings.

### SUMMARY OF THE INVENTION

The present invention relates to surfboards and particularly surfboards with removable surf fins and fin boxes and an adapter that provides the user with the ability to interchange fins of one manufacturer with the fin box of another manufacturer thus, allowing the surfer to tailor his surfing equipment to suit his needs. In particular, the invention includes an adapter that allows a surfer to safely and securely attach a FCS® fin to a Future® fin box on a surfboard or other aquatic sport equipment that employs use of an FCS® fin and Future® fin box.

Specifically the invention is a reusable and removable adapter for mounting into the cavity of a fin box wherein the fin box is configured within an aquatic sport craft. The adapter of the invention engages a fin to form a fin/adapter assembly with the fin/adapter assembly attaching to and fitting into the cavity of the fin box to hold the fin/adapter assembly securely into the fin box. In so doing, the invention allows a user the ability to attach a fin manufactured by a manufacturer and use the fin in conjunction with a fin box manufactured by a second, different manufacturer while also allowing the user to use a traditional surf key to attach the fin and fin/adapter assembly into the fin box.

The invention also relates to a fin mounting system for an aquatic sport craft such as a surfboard for example, and is a reusable adapter where the adapter engages a fin manufactured by a first manufacturer, and while engaged together, form a fin/adapter assembly, with the fin/adapter assembly thereafter being engaged into a fin box manufactured by a second, different manufacturer. Importantly, the fin, adapter and fin box are attached to the surfboard or aquatic watercraft using a traditional, standard surf key.

The invention further pertains and relates to a method of securing a fin of a first manufacturer to a fin box of a second, different manufacturer by means of an adapter wherein the adapter means comprises the adapters illustrated in any one of FIG. 1, 2, 5, 7 or 8, wherein the adapter attaches to a FCS® fin. The combination of the adapter and FCS® fin itself creates and forms a FCS® fin/adapter assembly, wherein the FCS® fin/adapter assembly attaches to a Future® fin box. The FCS® fin/assembly and Future® fin box can be located either in the center or outside positions, or both, of an aquatic sport craft.

Accordingly, the present invention is generally directed to an adapter that allows a surfer to easily use and interchange the fin of one manufacturer within the fin box of a different manufacturer. In particular, the invention is directed more specifically to a surfboard adapter that enables the reliable and efficient attachment of a FCS® fin to an existing Future® fin box. In particular, the invention includes a device and methods that allow the typical surfer to engage a FCS® fin into a Future® fin box wherein the fin will remain securely attached thereto in even the most rigorous wave conditions.

The invention is further directed to an adapter that allows a surfer to use Future® fins interchangeably with FCS® fin boxes on his surfboard. The adapter in both cases is suited to engage the fin and thereafter, the fin and engaged adapter can be inserted into the recesses of the desired fin box. The adapter and methods described herein expand the existing options available to a surfer, in essence allowing the surfer to use Future® fins with Future® fin boxes and, as described herein, FCS® fins with Future® fin boxes. This virtually doubles the level of variability that a surfer enjoys in employing use of the equipment that will best suit his needs.

### BRIEF DESCRIPTION OF THE DRAWINGS

FIG. 1 depicts the basic configuration of invention. In particular, the adapter shown is configured with a front and rear recess so to accommodate attachment of a FCS® fin. This combination (i.e., the adapter and fin) form a fin/adapter assembly. The fin/adapter assembly then fits into a Future® fin box.

FIG. 2 depicts a side profile perspective of the invention. As shown, the adapter provides for two recesses that will receive a FCS® fin and engage it securely thereto. The adapter bears a rounded front end with a flattened back end.

FIG. 3 depicts a view of the rear of the adapter wherein the adapter is secured to an FCS® fin via a setscrew that fits within the hole opening in the rear of the adapter.

FIG. 4 depicts a view of the front end of the adapter wherein the adapter is secured to an FCS® fin. As shown, the opening allows for a setscrew to be inserted into the hole opening with the screw being tightened with a traditional surf key.

FIG. 5 illustrates an FCS® fin as it is engaged in the adapter of the invention. Specifically, the fin fits within the adapter and as shown, is ready to be mounted into a Future® fin box.

FIG. 6 illustrates how an FCS® fin fits into and is secured to the adapter of the invention. An FCS® fin is placed into the two recesses of the adapter and is secured by means of two set screws that are tightened and secured to the adapter using a traditional surf key, hex head 3/32 inch.

FIG. 7 illustrates the adapter as it is engaged in a traditional surfboard. The FCS® fin and adapter attached to one another imitate the standard Future® fin allowing for interchangeability between FCS® fins with the Future® fin box system. The adapter and FCS® fin together as one unit are secured into the Future® fin box using standard methods for attaching Future® fins to Future® fin boxes.

FIG. 7 also illustrates the depth of the fin Future® fin boxes. As shown, the adapter employed at the center is of different dimension than the adapter of the outside fins in order to match the depth requirements of the Future® fin box.

FIG. 8 illustrates an alternative perspective in which the invention is engaged with a FCS® fin and fitted into a Future® fin box. Also provided is depiction of a Future® fin engaged in a typical Future® fin box. The illustration demonstrates that the invention allows the simultaneous use of a Future® fin in a Future® fin box while also employing the adapter to attach a FCS® fin to an existing Future® fin box to the same surfboard.

### DETAILED DESCRIPTION OF THE INVENTION

The present invention provides an apparatus and methods that allow a surfer to employ the fin of one manufacturer (i.e., FCS®) and to fit that fin into the fin box of another manufacturer (i.e., Future®) by means of an adapter that fits the fin to the fin box. In doing so, the invention allows the surfer greater flexibility in customizing their surfing equipment to his own configurations.

In a preferred embodiment, the adapter of the invention is primarily purposed to connect a FCS® fin into a Future® fin box set up. The adapter of the invention engages an FCS® fin, fitting the fin tightly so that it doesn't come loose. The fitting together of the FCS® fin and the adapter creates what is termed a fin/adapter or adapter/fin assembly. Thereafter, the user engages the adapter/FCS® fin (i.e., fin/adapter assembly) into the Future® fin box tightening the fin/adapter into the Future® fin box with a typical surf key.

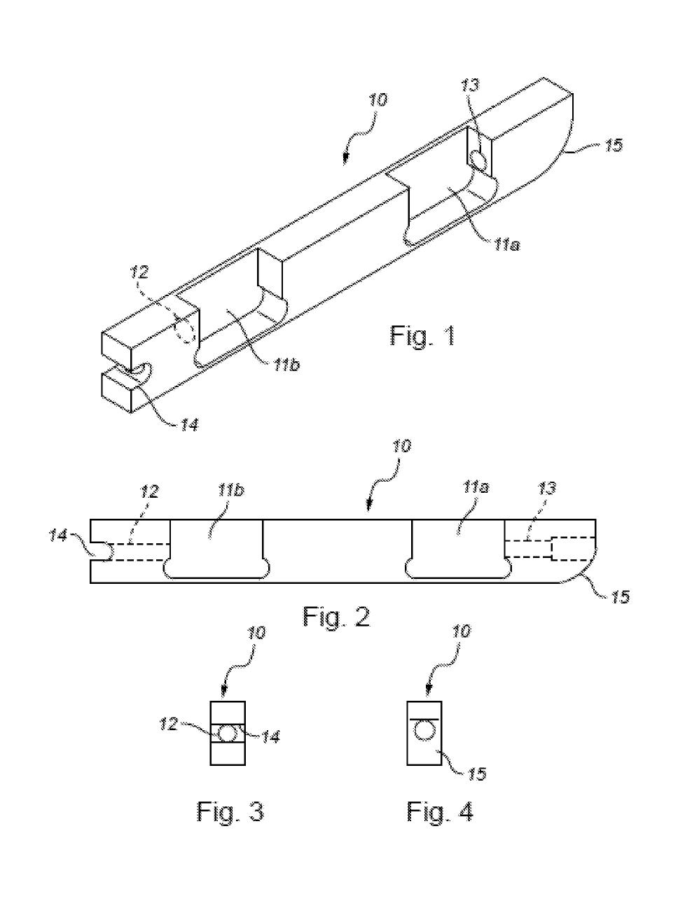

The adapter invention is provided in written description as well as in illustrative form in FIGS. 1-8. The claimed invention is the preferred embodiments as specifically provided in the Figures herein for example, in FIGS. 1, 2, 5, 6, 7 and 8. The reusable and removable adapter can be attached to the center or outside positions of an aquatic sport craft such as for example, a surfboard or any other craft that employs use of fins and fin boxes, fins and fin boxes manufactured for example by FCS® and Future® respectively. In a preferred embodiment, the adapter fitting into the center position, center fin and center fin box measures approximately a dimension of between 0.50 and 0.60 inches tall from bottom to top. The outside adapter of the invention (i.e., adapter that attaches to an outside FCS® fin and to an outside Future® fin box) measures approximately between 0.68 and 0.70 inches tall from bottom to top.

As envisioned herein, in another preferred embodiment, the invention also provides differently sized adapters. The outside fin and fin boxes are of different size than the center fin and fin box of a surfboard, aquatic sport craft or other aquatic sporting equipment that employ fins and fin boxes. A section of the FCS® fin that engages the Future® fin box is taller from top to bottom on the outside fin than the center fin. In such cases, the adapter of the invention is manufactured to be taller, from top to bottom on the outside fin and shorter from top to bottom on the center fin and fin box assembly.

As part of the preferred embodiment, the FCS® fin adapter can be used on a single FCS® fin and Future® fin box assembly configured on, for example, a surfboard, or the FCS® fin adapter can be used to fit up to two or more FCS® fins into up to two or more Future® fin boxes. The adapter of the invention will be reusable and removable so to be used over and over.

The terms as used herein will be understood by those of relevant skill in the art of surfboards and other aquatic craft that employ use of surfboard fins and fin boxes.

The term “aquatic sport craft” or the like, as used herein, refers to a surfboard or any other equipment that employs use of one or more fins and fin boxes in and during operation the surfboard or other equipment. Examples of an aquatic sport craft include but are not limited to surfboards, paddleboards and wind surfing boards.

The term “adapter/fin assembly”, or the like as used herein generally refers to the adapter of the invention wherein the adapter is attached to a fin as intended, wherein the fin is designed to fit into the fin box of a surfboard or other aquatic sport craft.

The term “outside fin” or the like as used herein, refers to the fin that is positioned in the non-center position (i.e., left or right of center position) of a surfboard or other aquatic sport craft. Such craft can employ two or more outside fins in their operation. Likewise, the term “outside adapter” or the like as used herein refers to an adapter of the invention wherein the adapter is attached to a fin positioned on the outside position of a surfboard or other aquatic sport craft. Further, as used herein, the outside fin relates to particular fin types such as for example a FCS® or Future® fin. Therefore, an outside fin is referred to as, for example, a “FCS® center fin” or the like.

The term “center fin” or the like as used herein, refers to the fin that is positioned in the center position of a surfboard or other aquatic sport craft. Generally only one center fin is employed in the operability of such craft however, it will be appreciated that more than one center fin is contemplated in the present invention. Further, as used herein, the center fin relates to particular fin types such as for example a FCS® or Future® fin. Therefore, a center fin is referred to as, for example, a “FCS® center fin” or the like. Likewise, the term “center adapter” or the like as used herein refers to an adapter of the invention wherein the adapter is attached to a fin positioned on the center position of a surfboard or other aquatic sport craft.

The term “outside fin/adapter assembly”, “outside adapter/fin assembly” or the like as used herein refers to the adapter of the invention wherein the adapter is attached to a fin as designed and intended of for example, to fin within the fin box of a surfboard. The assembly is thereafter fit into the fin box of a surfboard or other aquatic sport craft. Likewise, as used herein, the term “outside adapter/fin assembly” and the like, relates to particular fin types including FCS® and Future® for example. Further to this understanding is that a “FCS® outside fin/adapter assembly” refers to an adapter of the invention wherein the adapter is attached to an outside FCS® fin (i.e., FCS® fin that attaches to the outside, non-center) on a surfboard or other aquatic sport craft.

The terms “center fin/adapter assembly”, “center adapter/fin assembly” or the like as used herein refers to the adapter of the invention wherein the adapter is attached to a fin of for example, a surfboard. The assembly thereafter is designed to fit into the fin box of a surfboard or other aquatic sport craft. Likewise, as used herein, the term “center adapter/fin assembly” and the like, relates to particular fin types including FCS® and Future® for example. Further to this understanding is that a “FCS® center fin/adapter assembly” refers to an adapter of the invention wherein the adapter is attached to an center FCS® fin (i.e., FCS® fin that attaches to the center position) on a surfboard or other aquatic sport craft. Similarly, the terms “fin/adapter assembly”, “adapter/fin assembly” refers to such an assembly that will engage a fin box in either the center or outside positions on for example, a surfboard.

The term “outside fin box” or the like as used herein generally refers to the fin box of a surfboard or other aquatic sport craft wherein the fin box is configured and located in the left or right (i.e., non-center) position on the surfboard or craft. The term is also understood to include an outside fin box produced by a particular manufacturer such as Future® or FCS®. In describing a fin box manufactured by, for example, Future®, the fin box is described as a “Future® fin box” or similarly.

Likewise, the term “center fin box” or the like as used herein generally refers to the fin box of a surfboard or other aquatic sport craft wherein the fin box is configured and located in the center position of the surfboard or craft. The term also refers to particular manufacturers. For example, as used herein, a center fin box can be referred to as a “center Future® fin box” or the like, in the instance in which the fin box is configured into the center position of a surfboard and is manufactured by Future®.

The terms “attached to”, “engages with”, “mounting”, “mounted to” or the like as used herein refers to the engaging or attachment of two or more articles so that they fit together as intended and fit securely to one another. An example of the term is the instance in which a typical surfboard fin fits into (i.e., attaches to) the cavity of a fin box that has been built into the surfboard and to which the fin has been designed to fit. The term can also refer to the attachment of an adapter of the invention to a surfboard fin, the combination of which forms a fin/adapter or adapter/fin assembly. The term can also refer to the attachment of the adapter/fin assembly into the cavity of a fin box that has been built into a surfboard, with all attachments forming intended and secure attachments for each article. The terms also refer to the attachment of a fin/adapter assembly that is placed into the cavity and recesses of a fin box.

The term “fin” or the like as used herein, refers to the piece of equipment that is used on a surfboard of other type of aquatic sport craft wherein the fin assists in directing the craft to a desirable direction or motion by a user with the fin being designed to fit within the fin box. The fin as understood by those of skill in the art are located and configured on the lower portion of the craft with most aquatic sport craft possessing one or more fins per craft. Manufacturers of fins include FCS® and Future®.

Turning now to the substance of FIGS. 1 to 8 and the preferred embodiments of the invention. FIG. 1 provides a isometric view perspective of a preferred embodiment of the present invention. Specifically, the adapter 10 is configured with several elements including front and rear slots 11a, 11b, that act to engage the FCS® fin tabs 26a, 26b holding the tabs securely thereto. The adapter is further configured with a front curved end 15 and a slotted rear section 14 both of which act to engage the fitted configuration of the typical Future® fin box. In order to secure the fin/adapter combination to the Future® fin box two screws and screw holes are included in the adapter wherein a user can secure the entire assembly with a surf key.

FIG. 2 is a side view perspective of the embodiment of FIG. 1. Specifically, as shown, the adapter 10 is configured with cavities 11a, 11b that accommodate the tabs of a FCS® fin 26a, 26b therein. The rear slotted section 14 of the adapter element provides a recess 14 wherein the rear fin/adapter assembly will fit into the rear recess of a Future® fin box. As shown, the rear recess also provides a rear screw hole 12 wherein a screw fits to secure the rear section of the adapter to the Future® fin box. The front curved section of the adapter element 15 is also fitted with a screw hole 13 wherein the adapter/fin assembly is secured to the front-end recess of a Future® fin box.

FIG. 3 illustrates the rear slotted section of the adapter 10 wherein the slotted section 14 allows for fitting of the rear section of a Future® fin box therein. As shown, a user will employ use of a typical surf screw so to secure the rear section of the adapter/fin assembly into the rear section of a Future® fin box.

FIG. 4 illustrates the front curved section of the adapter 10 wherein the curved section 15 allows for fitting of the front section of a Future® fin box therein. As shown, a user will employ use of a typical surf screw so to secure the front curved section of the adapter/fin assembly into the front section of the Future® fin box.

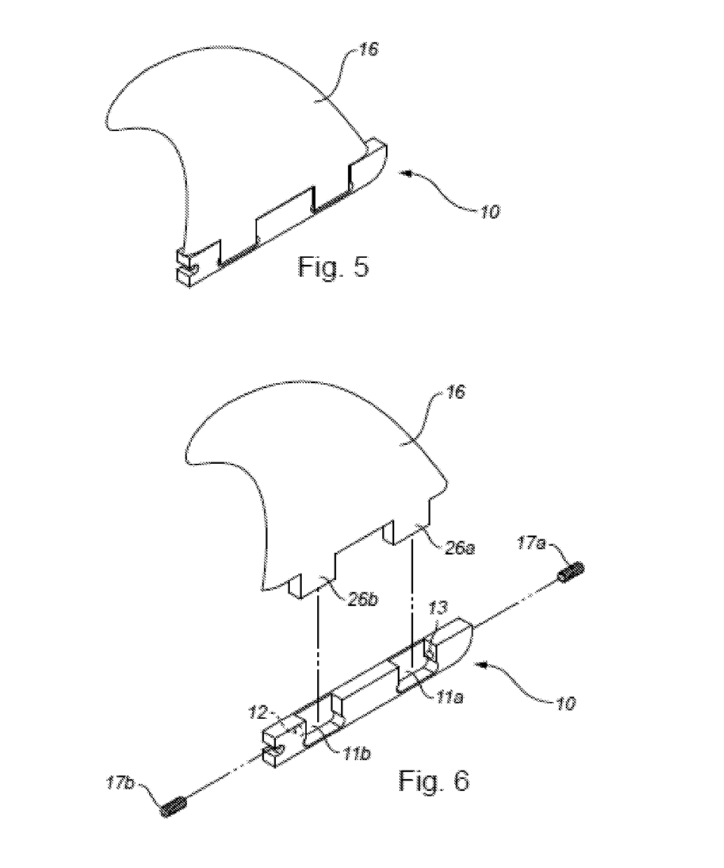

FIG. 5 illustrates an isometric view of the adapter/fin assembly. As shown, the adapter of the invention 10 is engaged to and fitted onto a FCS® fin 16 and secured thereto.

FIG. 6 illustrates how the adapter element 10 is engaged into the FCS® fin 16. As shown, the FCS® fin tabs 26a, 26b are moved into the recesses of the adapter 11a, 11b. The FCS® fin is thereafter secured to the adapter by means of a surf screw 17a, 17b in both the front and rear sections of the adapter wherein the screws are fit through screw holes 12, 13 in both the front and rear sections of the FCS® fin box cavity.

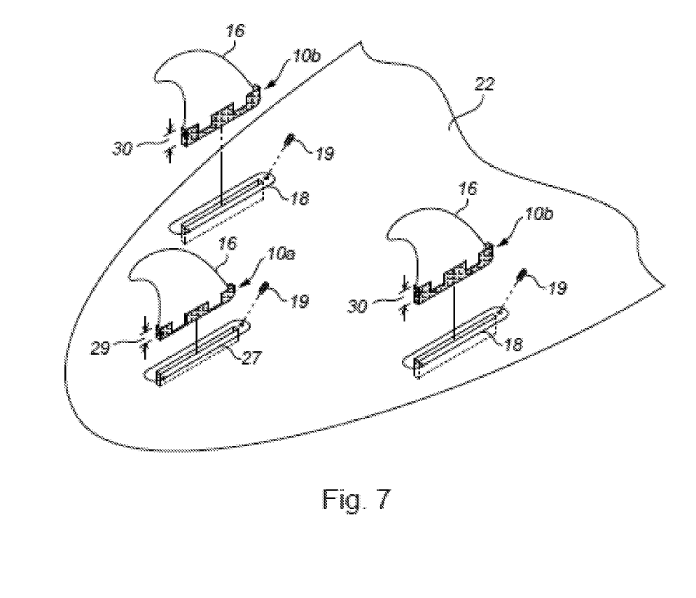

FIG. 7 illustrates a perspective of the invention wherein different sized adapters 16 of the invention are employed for either the center or outside fin positions on a surfboard or aquatic sport device 22. As shown, the center fin adapter 10a of the invention is employed to secure the center FCS® fin 16 to the center Future® fin box 27. Likewise, the outside fin adapter 10b is designed to fit the outside FCS® fin 16 and thereafter fit into the recess of the Future® fin box 18. The illustration further provides that the depth measurements between the outside and center fin adapters are different. For example, the adapter for the outside FCS® fin is longer from top to bottom 30 than is the measurement for the center FCS® fin adapter which is narrower from top to bottom 29. As previously described, the fin adapters 10a, 10b are secured to both the center and outside FCS® fins and thereafter to the Future® fin box by means of screws 19 which act to secure the fin/adapter assembly into the recess of the Future® fin box.

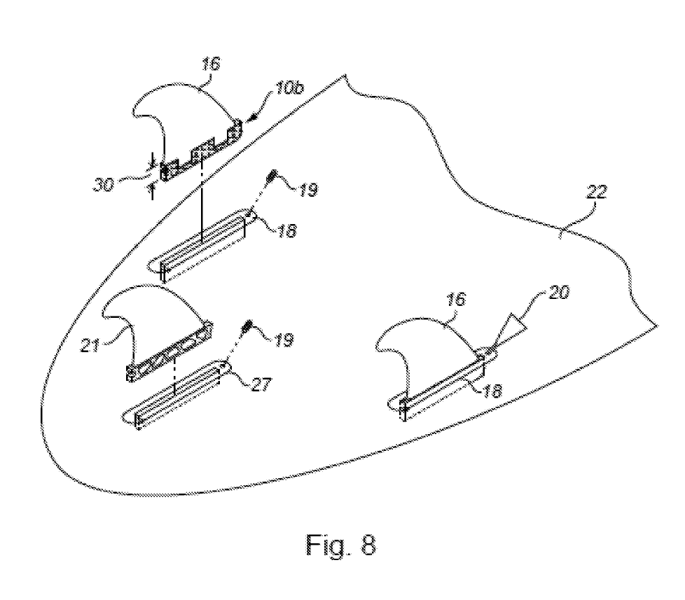

FIG. 8 illustrates how the adapter of the invention 10b is able to secure a FCS® fin 16 and how the adapter can be used for an individual fin. As shown, the adapter 10b is secured to a FCS® fin 16 on the outside fin position (top section of the illustration). In the center fin position however, the illustration also demonstrates that a Future® fin 21 can be used in a typical Future® fin box 27 and secured to a surfboard 22 like usual. Any combination or configuration of the FCS® fin adapter assembly and Future® fin can be used in the surfboard. The right outside section of the illustration shows that the adapter/fin assembly is fitted into a Future® fin box and secured by means of a surf screw and surf key 20. Accordingly, the invention does not require special tools to employ its use beyond what is typically used in the course of normal use of this type of equipment.

To manufacture the adapter of the invention, materials and methods as known in the art can be employed. For example, in preparing the adapter on a small scale (i.e., 100 units or fewer), the adapter will be created using CNC milling. The CNC machine automatically cuts the ABS plastic using a preprogrammed G-code from a 3D CAD model. This process therefore, allows for low start-up cost when producing the adapter on a small scale of 100 units or less. On a larger production scale, manufacturing will turn to plastic injection molding.

The plastic injection mold will be prepared from an aluminum alloy and created using a CNC machine. A negative mold will be injected with ABS plastic. The ABS plastic takes the shape of the mold making a positive part from the mold. There will be two jaws on the mold that open and close allowing the ABS plastic to be injected when closed then opened to release the adapter, known as the clam shell technique.

There are two techniques available in order to create the threading for the part where the two set screws will be used, located on either side of the adapter. Firstly, a through hole can be tapped to make thread and secondly a threaded insert may be installed. Each allowing, respectively, for a setscrew or socket head cap screw to be tightened upon the FCS® fin.

For manufacturing the adapter, materials such as those known in the art are utilized. For example, ethylene-vinyl acetate copolymer is used however, other materials such as polyurethane, silicone resin, poly (vinyl acetate) and other appropriate materials including for example aluminum and other metal based alloys, may be used likewise. The adapter can also be prepared using a more rigid material such as silicone based polymers or Teflon in which the material is molded at melting point temperatures and cooled to produce the necessary size and shape.

The FCS® fin teeth are thinner than the Future® fin box by forty thousand of an inch leaving the FCS® fin moving freely and loosely when inserted into a Future® fin box. The adapter adds material to the thickness of the FCS® teeth allowing the fin and adapter to grab the inside of the Future® fin box. The added thickness results in constructive interference that exerts outward force on the Future® fin box and inward force on the FCS® fin. These forces prevent the FCS® fin from wiggling while in the Future® fin box.

There are four physical directions the FCS® fin could move within the Future® fin box: X, Y, Z, and degree of rotation (wiggle). The X direction is parallel with the length of the fin box, measured at 4.40 inches. The Y direction is parallel with the thickness of the fin box, measured at 0.283 inches. The Z direction is parallel to the depth of the fin box, measured at 0.696 inches. The X direction is locked into place by the two FCS® tabs that fit into the adapter with a rectangular shape and are constrained into position by two set screws located on either side of the adapter. The Y direction is locked into place by the adapter's material thickness between the two FCS® fin tabs and the inside wall of the Future® fin box. The added thickness results in constructive interference preventing the fin from wiggling or having a degree of rotation. The Z direction is constrained by the depth of the adapters two rectangular tab where the Future® fin sits into, it is also constrained by the set screws on either side.

In a preferred embodiment of the invention the adapter can be configured to fit an FCS® fin wherein the FCS® fin will thereafter fit into a Future® fin box. In an alternative preferred embodiment, the adapter will be configured to engage a Future® fin wherein the engaged adapter/Future® fin will then be able to fit into the cavity of a FCS® fin box. The adapter in both cases will be secured by tightening the screws of the fin and fin box arrangements with a typical surf key

Certain advantages can be obtained in utilizing the present invention. Foremost, the invention allows a user the flexibility of tailoring their surfing equipment to his own specific needs. For example, the user can mix and match an FCS® fin and use it with for example, a Future® fin box. Benefits of the present invention over the prior art also include the ability to save money on purchasing an entire set of fins if only one fin needs replacing.

Although the invention has been described with reference to the above examples, it will be understood that modifications and variations are encompassed within the spirit and scope of the invention. Accordingly, the invention is limited only by the following claims.

What is claimed is:

1. A reusable and removable adapter for mounting into the cavity of a fin box wherein said fin box is configured within an aquatic sport craft, wherein said adapter engages a fin to form a fin/adapter assembly wherein, said fin/adapter assembly attaches to said cavity of said fin box to hold said fin/adapter assembly securely into said fin box thereby, allowing a user to attach said fin manufactured by a first manufacturer in conjunction with said fin box manufactured by a second, different manufacturer wherein said fin/adapter assembly is attached using a standard surf key.

2. The reusable and removable adapter of claim 1 wherein said fin is manufactured by FCS® and wherein said fin box is manufactured by Future®.

3. The reusable and removable adapter of claim 2 wherein said adapter is illustrated in any one of FIG. 1, 2, 5, 6, 7 or 8.

4. The reusable and removable adapter of claim 2 wherein said user can attach one or more of said fins on said aquatic sport craft by attaching one or more of said adapters to one or more of said fins to form one or more of said fin/adapter assemblies, wherein said one or more fin/adapter assemblies are attached to one or more of said fin boxes wherein said one or more fin boxes are manufactured by Future® and one or more of said fins are manufactured by FCS®.

5. The reusable and removable adapter of claim 2 wherein said adapter comprises a center adapter and is configured to engage said FCS® fin, wherein said FCS® fin comprises a center FCS® fin, wherein said center FCS® fin is designed to attach to said Future® fin box, wherein said Future® fin box comprises a center Future® fin box, wherein said center FCS® fin and said center adapter form a center FCS® fin/adapter assembly wherein said FCS® fin/adapter assembly attaches to said center Future® fin box, wherein said Future® fin box is in the center position of said aquatic sport craft.

6. The reusable and removable adapter of claim 2 wherein said adapter comprises an outside adapter and is configured to engage said FCS® fin, wherein said FCS® fin comprises an outside FCS® fin, wherein said outside FCS® fin is designed to attach to said Future® fin box, wherein said Future® fin box comprises an outside Future® fin box, wherein said outside FCS® fin and said outside adapter form an outside FCS® fin/adapter assembly, wherein said FCS® fin/adapter assembly attaches to said outside Future® fin box, wherein said Future® fin box is in the outside position of said aquatic sport craft.

7. The reusable and removable adapter of claim 5 wherein said center adapter comprises a dimension of between 0.50 and 0.60 inches tall from bottom to top.

8. The reusable and removable adapter of claim 6 wherein said outside adapter comprises a dimension of between 0.68 and 0.70 inches tall from bottom to top.

9. A fin mounting system for an aquatic sport craft comprising a reusable adapter wherein, said adapter engages a fin manufactured by a first manufacturer, wherein said adapter and said fin, while engaged together, form a fin/adapter assembly, wherein said fin/adapter assembly is engaged into a fin box manufactured by a second, different manufacturer wherein said fin/adapter assembly is attached using a standard surf key.

10. The fin mounting system of claim 9 wherein said adapter comprises the adapter of FIG. 1, 2, 5, 7 or 8.

11. The fin mounting system of claim 10 wherein said adapter attaches to and engages a FCS® fin wherein said attached and engaged FCS® fin and said adapter comprise an adapter/fin assembly, wherein said adapter/fin assembly is attached to a Future® fin box configured within said aquatic sport craft.

12. The fin mounting system of claim 11 wherein said adapter comprises an outside adapter and is manufactured to attach to an outside FCS® fin wherein, said outside adapter and said outside FCS® fin comprise an outside adapter/fin assembly wherein, said outside adapter/fin assembly attaches to an outside Future® fin box.

13. The fin mounting system of claim 11 wherein said adapter comprises a center adapter and is manufactured to attach to a center FCS® fin wherein, said center adapter and said center FCS® fin, when attached together, comprise a center adapter/fin assembly wherein, said center adapter/fin assembly attaches to a center Future® fin box.

14. The fin mounting system of claim 12 wherein said outside adapter comprises a dimension of between 0.68 and 0.70 inches tall from bottom to top and wherein said center adapter comprises a dimension of between 0.50 and 0.60 inches tall from bottom to top.

15. A method of securing a fin of a first manufacturer to a fin box of a second, different manufacturer by means of an adapter wherein said adapter means comprises the adapter illustrated in any one of FIG. 1, 2, 5, 7 or 8, wherein said adapter attaches to a FCS® fin wherein said attachment of said FCS® fin and said adapter form a FCS® fin/adapter assembly, wherein said FCS® fin/adapter assembly attaches to a Future® fin box, wherein said FCS® fin/assembly and said Future® fin box is located either in the center or outside positions, or both, of an aquatic sport craft.

16. The method of claim 15 wherein said adapter comprises an outside adapter and is manufactured to fit and attach to an outside FCS® fin wherein, said outside adapter and said outside FCS® fin comprise an outside FCS® fin/adapter assembly wherein, said FCS® fin/adapter assembly attaches to an outside Future® fin box.

17. The method of claim 15 wherein said adapter comprises a center adapter and is manufactured to fit and attach to a center FCS® fin wherein, said center adapter and said center FCS® fin comprise a center FCS® fin/adapter assembly wherein, said center FCS® fin/adapter assembly attaches to a center Future® fin box.

18. The method of claim 17 wherein a surfer attaches an outside or center fin that has been lost or broken with a standard surf key.

19. The method of claim 17 wherein said outside adapter comprises a dimension of between 0.68 and 0.70 inches tall from bottom to top.

20. The method of claim 17 wherein said center adapter comprises a dimension of between 0.50 and 0.60 inches tall from bottom to top.
